(19) United States
(12) Patent Application Publication
(10) Pub. No.: US 2010/0239349 A1
(43) Pub. Date: Sep. 23, 2010

(54) SHEET FEEDING APPARATUS AND PRINTER INCLUDING THE SAME

(75) Inventors: Norio Sakurai, Tokyo (JP); Mitsuhiro Mukasa, Kawasaki-shi (JP); Masakazu Nagashima, Kawasaki-shi (JP); Takeshi Kouda, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/724,789

(22) Filed: Mar. 16, 2010

(30) Foreign Application Priority Data
Mar. 18, 2009 (JP) 2009-066508

(51) Int. Cl. B41J 13/02; B65H 5/22

(52) U.S. Cl. 400/642; 271/11

(57) ABSTRACT

An apparatus includes a supporting surface including a curved surface that is convex in a direction opposite to gravity, the supporting surface supporting a sheet under the weight of the sheet, wherein an air venting path is disposed at the supporting surface, the air venting path allowing air to be vented from an air space between the supporting surface and the sheet placed on the supporting surface; a holding section holding an end of the sheet, the sheet drooping toward both sides of the supporting surface; and a feeding path through which the sheet is fed from the holding section side to a processing unit.

### BACKGROUND OF THE INVENTION

1. Field of the Invention

The present invention relates to a printer including a sheet feeding mechanism in which a sheet is manually inserted.

2. Description of the Related Art

Japanese Patent Laid-Open No. 2001-130097 describes a printer including a mechanism that feeds a rolled sheet and a cut sheet (single sheet) to a printing unit. The rolled sheet is rotatably set on a holder and is protected by being covered with an openable cover. The cut sheet is inserted into an insertion slit and manual-feed printing is performed.

A user may want to perform manual-feed printing using a long cut sheet. However, it is not assumed that a long cut sheet is used in the printer described in Japanese Patent Laid-Open No. 2001-130097. If a user wants to perform manual-feed printing on a long cut sheet, the user has to insert one end of the long sheet into the insertion slit and place the remaining part of the sheet on an upper surface of the cover that serves as a supporting surface. Because the sheet is long, the trailing end of the sheet extends beyond the supporting surface and droops downward from the cover under its own weight. When a user places a long sheet on the supporting surface in this manner, a phenomenon described below may occur. Referring to FIGS. 11A to 11F, movement of the sheet in the phenomenon will be described.

FIGS. 11A to 11F illustrate the sequential movement of a cut sheet that is placed on a rolled-sheet cover 220 by a user and then supported by the rolled-sheet cover 220 when the user performs manual-feed printing. FIG. 11A illustrates a state in which the user holds a cut sheet C with his/her hand H and the user is about to insert a first end of cut sheet C into an entrance E of a feeding path 23. The user aligns the first end of the cut sheet C with the entrance E. FIG. 11B illustrates a state in which the user moves the cut sheet C downward. The first end and the second end of the cut sheet C, which droop downward, respectively contact a region 220e of the rolled-sheet cover 220 (on the entrance E side) and a region 220f of the of the rolled-sheet cover 220 (on a side opposite the entrance E side). At this time, a space A (hatched region in FIGS. 11B to 11E) is formed between the supporting surface of the rolled-sheet cover 220 and the back surface of the cut sheet C. As illustrated in FIG. 11C, when the user releases the cut sheet C from his/her hand H, the cut sheet C begins to fall due to gravity. A part of air in the space A is gradually vented from lateral sides of the cut sheet C (in directions perpendicular to the paper surface of FIGS. 11A to 11F). However, when the sheet has a large width, the remaining air is not smoothly vented from the lateral sides of the sheet. The remaining air that has been stuck generates a gap in the region 220f and is vented to the outside through the gap as indicated by an arrow S. Because the gap is an air space, there is substantially no friction between the cut sheet C and the surface of the rolled-sheet cover 220. Therefore, the cut sheet C rapidly slides on the surface of the rolled-sheet cover 220 and falls toward the second end side. The longer the cut sheet C, the higher the falling speed is, because the second end side of the cut sheet C becomes heavier than the first end side. Subsequently, as illustrated in FIG. 11D, the first end of the cut sheet C enters the entrance E through the insertion slit, and the first end side of the cut sheet C stops falling. However, the second end side of the cut sheet C continues to fall rapidly. The first end side of the cut sheet C, which has been inserted into the entrance E, is dragged by the momentum of the second end side of the cut sheet C, which falls rapidly. As illustrated in FIG. 11E, the entire sheet moves in a falling direction, because there is substantially no friction in the space A and the gap in the air venting path indicated by the arrow S. Finally, as illustrated in FIG. 11F, the entirety of the cut sheet C falls toward the second end side without being held by the supporting surface. This phenomenon more frequently occurs when the cut sheet C is longer and wider.

### SUMMARY OF THE INVENTION

An apparatus according to an aspect of the invention includes a supporting surface including a curved surface that is convex in a direction opposite to gravity, the supporting surface supporting a sheet under a weight of the sheet, wherein an air venting path is disposed at the supporting surface, the air venting path allowing air to be vented from an air space between the supporting surface and a back surface of the sheet placed on the supporting surface; a holding section holding an end of the sheet, the sheet drooping toward both sides of the supporting surface; and a feeding path through which the sheet is fed from the holding section side to a processing unit.

Further features of the present invention will become apparent from the following description of exemplary embodiments with reference to the attached drawings.

### BRIEF DESCRIPTION OF THE DRAWINGS

FIG. 1 is a cross-sectional view of a printer.

FIG. 2 is an enlarged cross-sectional view of a sheet feeding unit.

FIGS. 3A to 3C illustrate examples of the shape of a rolled-sheet cover.

FIGS. 4A to 4C illustrate an example of an air venting path including a groove.

FIGS. 5A to 5C illustrate an example of an air venting path including a protruding section having a continuous protrusion.

FIG. 6 illustrates an example of an air venting path including a protruding section having discrete protrusions.

FIGS. 7A to 7C illustrate an example of an air venting path including holes.

FIG. 8 illustrates holes having a louvered shape.

FIGS. 9A and 9B illustrate another example of the rolled-sheet cover.

FIGS. 10A to 10F illustrate movement of a sheet when the sheet is set during manual-feed printing.

FIGS. 11A to 11F illustrate movement of a sheet when the sheet is set in an existing sheet feeding apparatus.

### DESCRIPTION OF THE EMBODIMENTS

Embodiments of the invention will be described with reference to the drawings. The embodiments are only exemplary and the scope of the invention is not limited thereto.

A large-format inkjet printer will be described as an example. The printer according to an embodiment of the invention can be applied not only to a single function printer, but also to a so-called multifunction printer having a copying function, an image scanning function, and the like. Various methods of inkjet printing such as a method using an exothermic body, a method using a piezoelectric device, a method using an electrostatic element, and a method using a microelectromechanical system device can be used. The printing method is not limited to inkjet printing, and various methods such as an electrophotographic method and a thermal transfer method can be used.

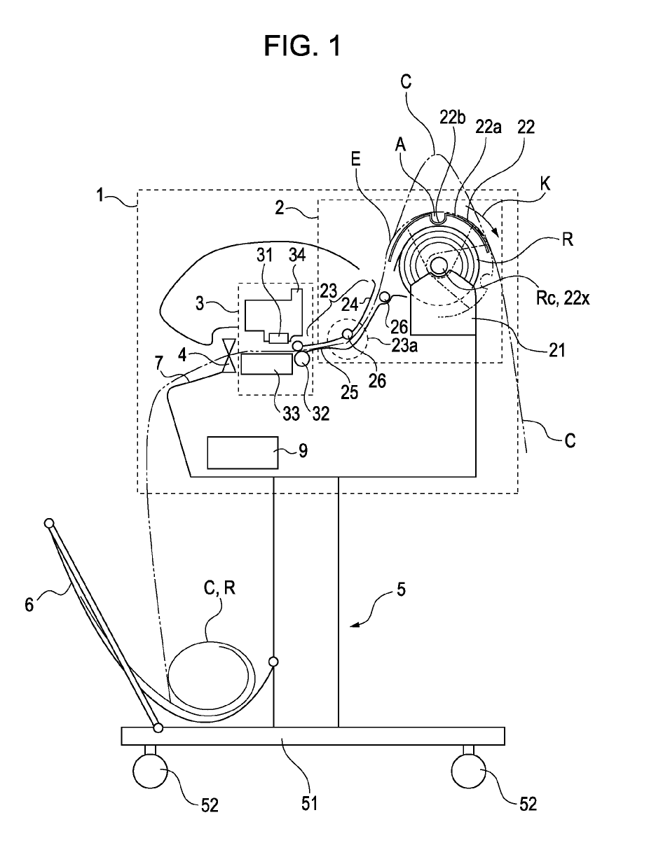

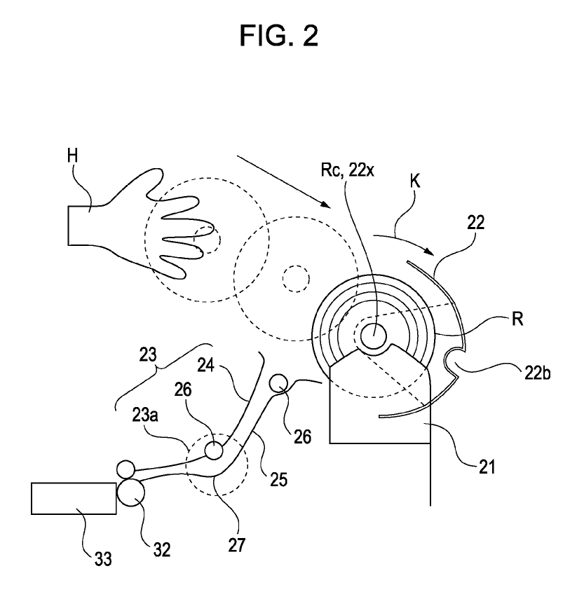

FIG. 1 is a cross-sectional view illustrating the structure of a main part of a printer according to the embodiment. FIG. 2 is an enlarged cross-sectional view of a sheet feeding unit 2. The printer includes a printer body 1, the sheet feeding unit 2, a printing unit 3, a cutter 4, a stand 5, a basket 6, an ejection guide 7, and a controller 9. The sheet feeding unit 2 corresponds to a sheet feeding apparatus, and the printing unit 3 corresponds to a processing unit. The printer body 1, which holds components of the printer, is supported by the stand 5 at a height above the floor at which a user can easily operate the printer. Casters 52 are attached to leg portions 51 of the stand 5 so that the printer can be easily moved on the floor. The controller 9, which includes a CPU, a memory, and various I/O interfaces, controls operational sections of the printer.

The sheet feeding unit 2 includes a rolled-sheet holder 21, a rolled-sheet cover 22, and a feeding path 23. The rolled-sheet holder 21 holds the rolled sheet R from both sides in such a manner that the rolled sheet R can rotate around a rotation axis Rc. The rolled-sheet cover 22, which covers an upper part of the rolled sheet R, can be rotated around an axis that is coaxial with the rotation axis Rc. Thus, the rolled-sheet cover 22 can be opened so as to load a rolled sheet. The feeding path 23 guides the rolled sheet R, which is held by the rolled-sheet holder 21, or a cut sheet C, which is manually fed as described below, to the printing unit 3 that corresponds to the processing unit. In the present specification, the cut sheet C and the rolled sheet R may be collectively referred to as the “sheet”. When feeding the rolled sheet R, a user inserts the leading end of the rolled sheet R held by the rolled-sheet holder 21 into an entrance E so that the rolled sheet R is fed through the feeding path 23 to the printing unit 3. When performing manual-feed printing on the cut sheet C, a user holds the cut sheet C with his/her hand and aligns one end of the sheet C with the entrance E. Then, the user releases the cut sheet C from his/her hand so as to place the cut sheet C on an outer peripheral surface of the rolled-sheet cover 22. When the rolled-sheet cover 22 is in a closed state, an upper part of the outer peripheral surface of the rolled-sheet cover 22 serves as a supporting surface 22a and holds the cut sheet C.

The feeding path 23 includes an upper guide 24 and a lower guide 25 that face each other. A gap (narrow path) between the upper guide 24 and the lower guide 25 serves as a sheet-guiding path. The feeding path 23 extends diagonally downward from the entrance E into which the sheet is inserted. The feeding path 23 is curved at a curved section 23a (a holding section) located in a middle portion of the feeding path 23 so as to form a substantially horizontal guiding path to the printing unit 3. When applicable, auxiliary driven rollers 26 are disposed on the upper guide 24 and the lower guide 25 so that the sheet can smoothly pass through the feeding path 23. One of the auxiliary driven rollers 26 is disposed on the upper guide 24 at a portion near the curved section 23a, because the sheet contacts the portion when the sheet is being conveyed and thereby a conveying load increases. At the curved section 23a, the gap between the lower guide 25 and the upper guide 24 is wider than other portions. That is, at the curved section 23a, the lower guide 25 has a scooped-out portion 27 at which the entry side of the lower guide 25 has a scooped-out shape. The function of the scooped-out portion 27 will be described. If the curved section does not have a scooped-out shape, a high sliding friction is generated when the leading end of the sheet is inserted into a narrow portion of the curved section and the movement direction of the sheet is changed. This is because, the leading end of the sheet is to be inserted with a force stronger than the force used to insert the other portions of the sheet, because the leading end of the sheet is more rigid than the other portions. Moreover, the contact portion at which the edge of the leading end of the sheet contacts the lower guide is subjected to a strict condition regarding a contact pressure and a contact angle so that the leading end can be successfully guided downstream. That is, at the edge of the leading end of the sheet, the contact pressure is locally high, and hence the sliding friction is high. Moreover, the edge of the leading end of the sheet may be caught on the lower guide, because the contact angle between the edge and the lower guide is almost a right angle. Thus, when inserting a sheet, a user may feel an unpleasant sensation because the insertion force varies considerably between the curved section and other portions. Considerable variation of load occurring while the sheet is conveyed may be mechanically undesirable in terms of ease of use. Therefore, in the embodiment, the scooped-out portion 27 is formed in the curved section so as to reduce the variation in the insertion force. That is, the entry side of the curved section 23a of the lower guide 25 has a downward scooped-out shape so as to reduce an insertion load generated when the leading end of the sheet changes its movement direction. With the scooped-out portion 27 being formed, the leading end of the sheet can be curved over a longer distance (which virtually reduces rigidity) and the contact angle between the edge of the leading end of the sheet and the lower guide can be decreased. Thus, a user can easily insert a sheet because an insertion load generated when the leading end of the sheet changes its movement direction is reduced.

A higher insertion load is generated when the leading end of the sheet passes through the curved section 23a of the feeding path 23 than when the leading end of the sheet passes through other portions. By utilizing this effect, the curved section 23a serves as a holding section that holds a first end of the sheet with a predetermined holding force, when the sheet is supported by the supporting surface 22a and droops on both sides of the rolled-sheet cover 22 as described below. The predetermined holding force is strong enough to prevent falling of the sheet on a side of the rolled-sheet cover 22 opposite the side of the curved section 23a owing to the weight of a portion of the sheet drooping on the side opposite the side of the curved section 23a. The predetermined holding force is not strong enough to make a user feel an unpleasant sensation when, for example, the user inserts or removes a sheet. The holding section of the feeding path 23 is not limited to a mechanism that holds a sheet by using a conveying load generated at the narrow path. Other mechanisms, such as feeding rollers, may be disposed in the feeding path 23 so as to nip and feed the sheet. In short, it is sufficient that the holding section include a mechanism configured to hold the first end of the sheet, when the sheet droops on both sides of the supporting surface 22a, with the predetermined holding force described above and prevent the sheet from sliding off a side of the supporting surface 22a opposite the side of the feeding path 23.

The printing unit 3 performs printing at a printing position on the sheet that has been fed from the sheet feeding unit 2. The printing unit 3 includes conveying rollers 32, which convey the sheet, and a platen 33. The platen 33 guides the sheet from below while the sheet moves in the printing position. The printing unit 3 further includes a print head 31 and a carriage 34. The print head 31 faces the platen 33 with the sheet therebetween. The carriage 34 removably holds the print head 31, and scans the sheet in a reciprocating manner in directions perpendicular to the sheet conveying direction. While printing is performed, ejection of ink from the print head 31, in time with the reciprocation of the carriage 34, and conveyance of the sheet are alternately repeated, whereby a two-dimensional image is formed on the sheet. The cutter 4 is disposed downstream of the printing position so as to cut the rolled sheet R. The cut sheet C on which an image has been printed or the rolled sheet R that has been cut by the cutter 4 slides on the inclined surface of the ejection guide 7 under its own weight and falls into the basket 6. The basket 6, which is supported by the stand 5, receives the sheet that has been ejected. The basket 6 can be folded or contracted so as to save space when the basket 6 is not used.

The structure of the sheet feeding unit 2, which characterizes the present embodiment, will be described in detail. The rolled-sheet holder 21 holds the rolled sheet R, which is continuous and rolled around a core, so that the rolled sheet R can rotate around the rotation axis Rc. The leading end of the rolled sheet R is unrolled and fed through the feeding path 23 toward the printing unit 3. The rolled-sheet cover 22 covers the upper surface of the rolled sheet R held by the rolled-sheet holder 21 so as to protect the rolled sheet R from dust or the like. The rolled-sheet cover 22 can be rotated between a position at which the rolled-sheet cover 22 covers the upper surface of the rolled sheet R (a state illustrated in FIG. 1, hereinafter referred to as the “closed position”) and a position at which a user loads the rolled sheet R to the rolled-sheet holder 21 (a state illustrated in FIG. 2, hereinafter referred to as the “open position”). FIG. 2 illustrates a state in which a user loads a rolled sheet after making the rolled-sheet cover 22 be in the open position by rotating the rolled-sheet cover 22 in a direction indicated by an arrow K. In the open position, the upper front portion of the printer body 1 (the upper left side in FIGS. 1 and 2) is opened, and the user loads the rolled sheet through the opening while holding the rolled sheet with both hands H.

The rolled-sheet cover 22 has a rotation axis 22x that is disposed at an appropriate position so that the inner surface of the rolled-sheet cover 22 does not contact the outer peripheral surface of the rolled sheet R when the rolled-sheet cover 22 is rotated between the open position and the closed position. For this purpose, the rotation axis 22x is to be coaxial with the rotation axis Rc of the rolled sheet R held by the rolled-sheet holder 21. When the rotation axes are coaxial with each other, the back side of the printer body 1 does not bulge toward the back side when the rolled-sheet cover 22 is in the open position, whereby the footprint of the printer can be reduced. In the present specification, the term “coaxial” is not limited to the meaning that the rotation axes are strictly identical to each other, and includes the meaning that the rotation axes are substantially identical to each other to the extent that the above-described benefit is obtained.

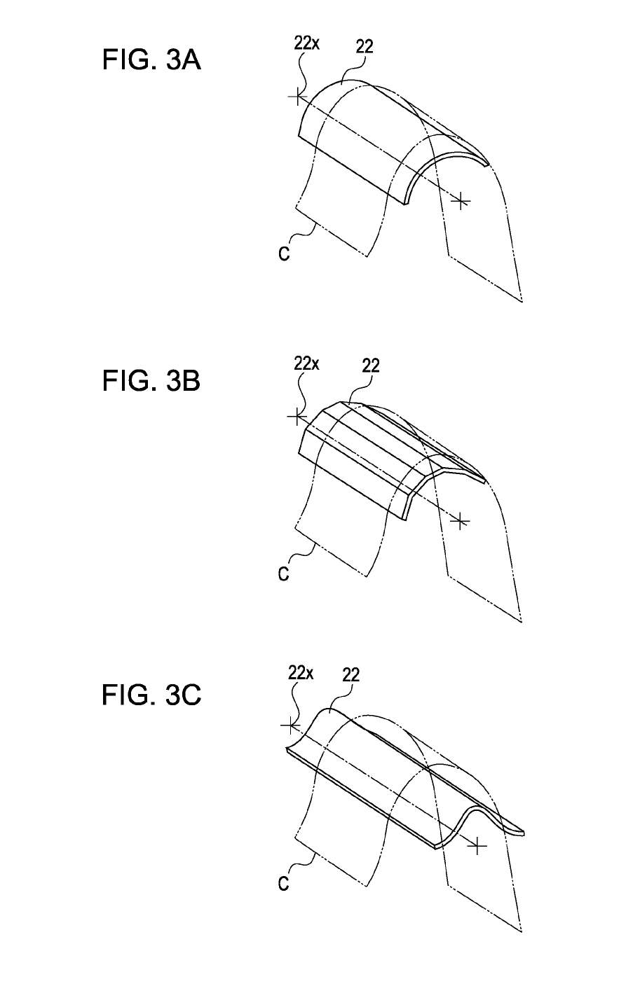

When the rolled-sheet cover 22 is in the closed position, the outer peripheral surface of the rolled-sheet cover 22 serves as a supporting surface that holds the cut sheet C during manual-feed printing. When the rolled-sheet cover 22 is in the closed position, the supporting surface 22a of the rolled-sheet cover 22 has a shape including a gently curved surface that is convex upward in a direction opposite to gravity. Therefore, the cut sheet C, which is supported on the supporting surface 22a under its own weight, is made to take a shape that is convex upward in a direction opposite to gravity as with the supporting surface 22a. FIG. 3A illustrates an example of the shape that is a cylindrical surface having an arc-shaped cross section (or a shape similar to this shape). The rotation axis of the cylindrical surface is coaxial with the rotation axis 22x of the rolled-sheet cover 22. The cross section is not limited to a perfect circle, and may have an elliptical arc shape. FIG. 3B illustrates an example of the shape including a surface having a polygonal cross section, and FIG. 3C illustrates an example of the shape including a surface having a bell-shaped cross section. Other shapes can be used as long as the shape includes a surface that can hold the cut sheet C in such a manner that the cut sheet C has a shape that is gently convex upward. The shape illustrated in FIG. 3B does not include a curved surface because the surfaces of the polyhedron are flat. However, the shape is regarded as a “curved surface” in the present specification, because the shape can be approximated to that of a curved surface.

An example in which the outer side of the rolled-sheet cover 22 includes a cylindrical surface that serves as a supporting surface will be described. The cylindrical surface has an appropriate shape because the cut sheet C can naturally contact the surface. As illustrated in FIG. 1, when the rolled-sheet cover 22 is in the closed position, an air venting path 22b is disposed near the apex of the supporting surface 22a having the cylindrical shape (at the top in the direction opposite to gravity). When the cut sheet C is placed on the supporting surface 22a, a space A that contains air is temporarily formed between the supporting surface 22a and the back surface of the cut sheet C (the surface facing the supporting surface 22a). The space A communicates with the outside through the air venting path 22b, so that air is smoothly and rapidly vented from the space A to the outside. Movement of the sheet at this time will be described below in detail.

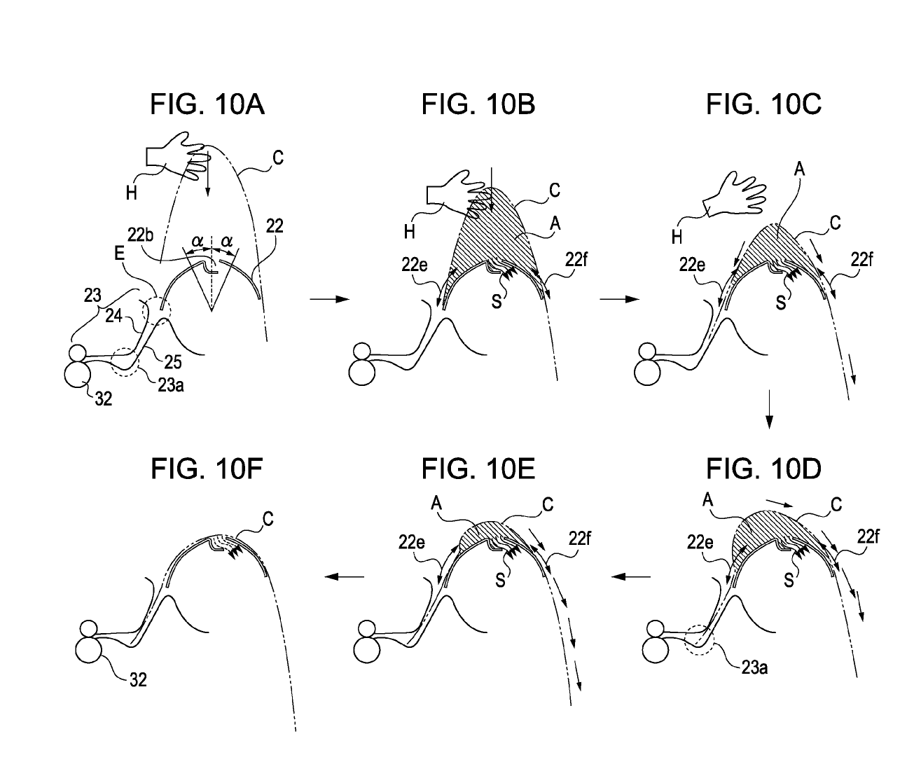

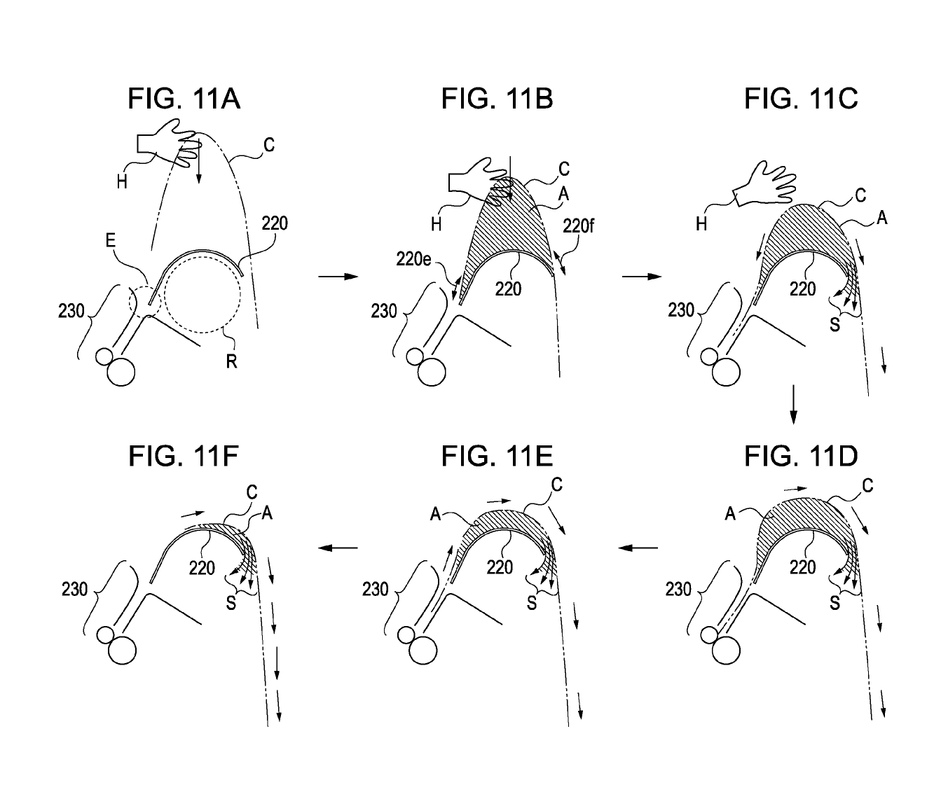

FIGS. 10A to 10F illustrate the sequential movement of a cut sheet when a user places the sheet on the rolled-sheet cover 22 and the sheet is supported by the rolled-sheet cover 22 during manual-feed printing. The benefit of the embodiment will become clear by contrasting the movement with the movement illustrated in FIGS. 11A to 11F. FIG. 10A illustrates a state in which a user holds the cut sheet C with his/her hand H and the user is about to insert the first end of cut sheet C into an entrance E of the feeding path 23. The user aligns the first end of the cut sheet C with the entrance E. FIG. 10B illustrates a state in which the user moves the cut sheet C downward. The first end and the second end of the cut sheet C, which droop downward, respectively contact a region 22e (on the entrance E side) and a region 22f (on a side opposite the entrance E side) at ends of the rolled-sheet cover 22. The first end of the sheet is positioned above the slit of the entrance E. At this time, the space A (hatched region in FIGS. 10B to 10E) is formed between the supporting surface of the rolled-sheet cover 22 and the back surface of the cut sheet C. The space A corresponds to an air space. As illustrated in FIG. 10C, when the user releases the cut sheet C from his/her hand H, the cut sheet C begins to fall due to gravity. Air in the space A is gradually vented through the air venting path 22b and from lateral sides of the rolled-sheet cover 22 (in directions perpendicular to the paper surface of FIGS. 10A to 10F), so that the volume of the space A gradually decreases over time. Because the air is not only vented from the lateral sides of the rolled-sheet cover 22 but also through the air venting path 22b in a direction indicated by an arrow S (toward the back side of the rolled-sheet cover 22), the air is smoothly and rapidly vented from the space A even if the sheet has a large width. Therefore, in contrast to the case illustrated in FIG. 11C, a gap is not generated in the region 22f and the air is not vented from the gap, so that the cut sheet C surface contacts the supporting surface in the region 22f and friction is applied the cut sheet C. Subsequently, as illustrated in FIG. 10D, the first end of the cut sheet C enters the entrance E through the insertion slit, the first end of the cut sheet C stops falling, and the sheet is held by the curved section 23a with a predetermined holding force. As illustrated in FIG. 10E, the second end of the cut sheet C (on a side opposite the entrance E side) continues to fall at a moderate and appropriate speed under frictional resistance in the region 22f, and the air in the space A continues to be vented. Because the first end of the cut sheet C is stopped at the entrance E, the back surface of the cut sheet C first contacts the supporting surface of the rolled-sheet cover 22 on the entrance E side. As the air is vented from the space A, the area at which the cut sheet C contacts the supporting surface gradually extends toward the second end of the cut sheet C. Finally, as illustrated in FIG. 10F, almost all the air in the space A is vented from the space A, so that the cut sheet C contacts the entire supporting surface of the rolled-sheet cover 22. At this time, the force with which the curved section 23a holds the first end of the cut sheet C and the friction between the cut sheet C and the supporting surface of the rolled-sheet cover 22 generate a braking force that is strong enough to stop the second end of the cut sheet C from falling. Due to the braking force, the second end of the cut sheet C stops falling and is reliably held on the supporting surface of the rolled-sheet cover 22. When the cut sheet C is held in this manner, the user further inserts the leading end of the cut sheet C from the entrance E, so that the leading end of the sheet is nipped between the conveying rollers 32. Subsequently, the sheet is fed to the printing unit.

The air venting path 22b is to be formed at least within a vertically projected area of the rolled-sheet cover 22 in the closed position. The air venting path 22b is to be at a position that allows air to be vented from the air space as much as possible when the cut sheet C moves as illustrated in FIGS. 10A to 10F. For this purpose, the center of the air venting path 22b is disposed in a region that is between the regions 22e and 22f (see FIG. 10B) at which portions of the cut sheet C that droop on both sides of the rolled-sheet cover 22 contact the rolled-sheet cover 22 when a user holds the cut sheet C above the supporting surface 22a and then lets the sheet fall. The center of the air venting path 22b can be disposed at a position separated by an angle α (see FIG. 10A) equal to or smaller than 30° or a distance equal to or smaller than 50 mm from the apex (highest point) of the upwardly convex rolled-sheet cover 22 in the closed position. The center of the air venting path 22b can be disposed at a position separated by an angle α equal to or smaller than 15° or a distance equal to or smaller than 20 mm from the apex of the upwardly convex rolled-sheet cover 22 in the closed position. The air venting path 22b can be disposed at a position including the apex of the upwardly convex shape of the rolled-sheet cover 22 in the closed position.

As described above, air can be rapidly vented from the air space, which is formed between the supporting surface 22a and the back surface of the sheet placed on the supporting surface 22a, through the air venting path 22b. Specific examples of the structure of the air venting path will be described below.

### First Example of Air Venting Path

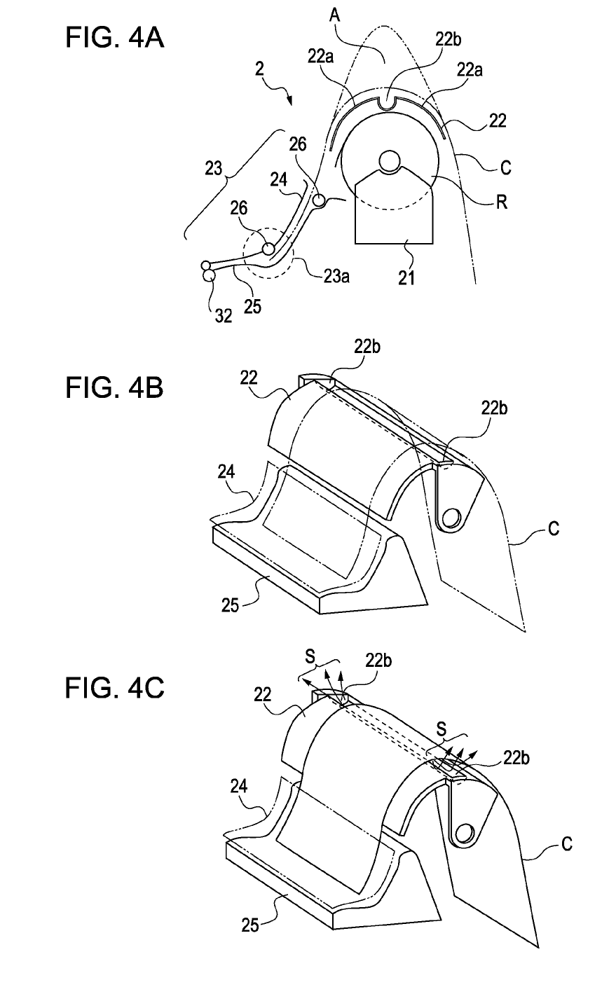

FIGS. 4A to 4C illustrate an example of the air venting path 22b that is a groove formed in the supporting surface. FIG. 4A is a cross-sectional view, and FIG. 4B is a perspective view of the sheet feeding unit 2. The cut sheet C, which is supported, is indicated by a two-dot chain line. FIG. 4C conceptually illustrates a state in which air is vented through the air venting path 22b. In the first example, the air venting path 22b is formed near the apex of the supporting surface 22a and extends in the longitudinal direction of the rolled-sheet cover 22 (a direction perpendicular to the direction in which the sheet is fed). The air venting path 22b is a concave groove formed in the supporting surface and having a small arc-shaped cross section. The groove extends in the supporting surface over a length that is greater than the maximum width of the cut sheet C to be used in the printer body 1. Therefore, whatever the size of the sheet may be, the air in the space A between the cut sheet C and the supporting surface 22a is rapidly vented through the air venting path 22b toward the lateral sides of the rolled-sheet cover 22 as indicated by an arrow C in FIG. 4C. As a result, the cut sheet C rapidly contacts the supporting surface 22a, and is reliably supported by the supporting surface 22a.

The groove is not limited to a linear groove that is continuous in the width direction of the cut sheet C. There may be a plurality of grooves, the groove may be curved, or there may be partitions in the groove. The cross section of the groove is not limited to an arc shape. As long as the groove has a cross-sectional area that allows a sufficient amount of air to be vented therethrough, the cross section may have a shape of a polygon or a free curve. That is, it is sufficient that the groove of the air venting path 22b have a shape that allows air to be rapidly vented from the air space between the supporting surface and the back surface of the sheet placed on the supporting surface.

As described above, the groove, which is formed in the supporting surface and serves as an air venting path, has a length in the width direction of the sheet larger than the maximum width of the sheet to be used. This structure has the following benefits.

(1) Because the air venting path includes the groove, the air venting path does not affect the position and posture of the sheet. (The air venting path does not cause a part of the sheet to rise above the supporting surface.) Thus, the sheet is not likely to be creased or bent while the sheet is being conveyed. Even if the sheet is placed on the rolled-sheet cover 22 for a long time, the sheet is less likely to be creased, bent, or curled.
(2) When opening or closing the rolled-sheet cover 22, a user can hook his/her finger in the groove so as to have a handhold, whereby the groove improves the operability of opening and closing the rolled-sheet cover 22.
(3) The groove serves as a strong reinforcement rib, so that the strength of the rolled-sheet cover 22 in the longitudinal direction and in the twisting direction is increased. Thus, the rolled-sheet cover 22 does not substantially deform irrespective of whether a user holds the center or any other position of the groove when the user opens or closes the rolled-sheet cover 22. Even if an external pressure is inadvertently applied to the rolled-sheet cover 22, the rolled sheet R is protected by the rolled-sheet cover 22 that is resistant to being deformed.
(4) Because the groove serves as a strong reinforcement rib, the rolled-sheet cover 22 including the groove can have a strength the same as that of a rolled-sheet cover without a groove with a weight lighter than that of the cover without the groove. Thus, the weight of the entire apparatus can be reduced. Moreover, the lighter the rolled-sheet cover 22, the more easily a user can open and close the rolled-sheet cover 22.
(5) Because the rolled-sheet cover 22 does not have a protruding portion, the footprint of the apparatus does not increase when the rolled-sheet cover 22 is in the open position.
(6) A user can pick up a sheet that has been placed on the rolled-sheet cover by inserting his/her finger from a lateral side of the groove at which the sheet does not contact the rolled-sheet cover so as to lift the sheet. Thus, operability for a user is improved.

### Second Example of Air Venting Path

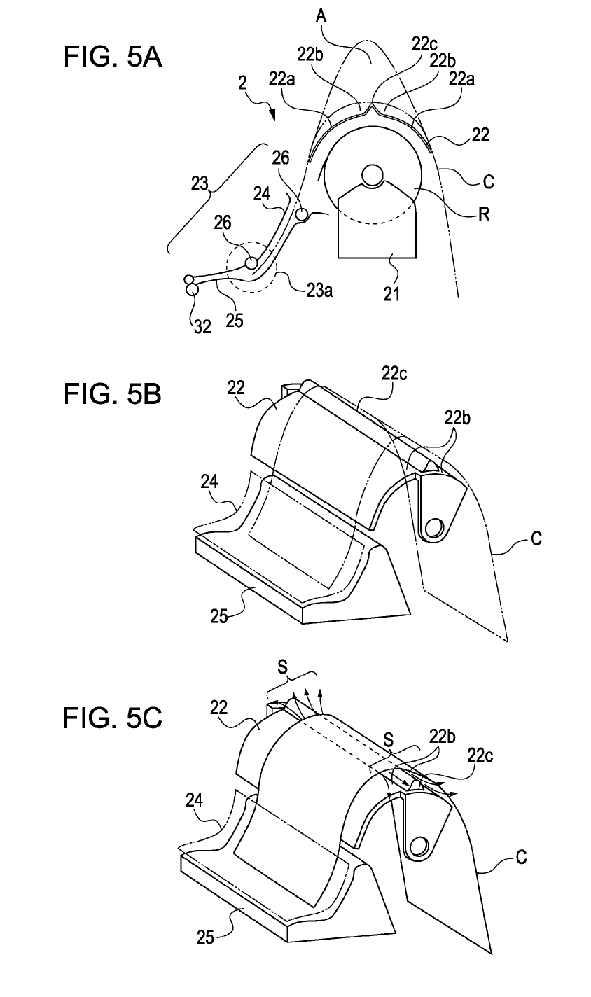

FIGS. 5A to 5C illustrate a second example of the air venting path 22b that is a junction between the supporting surface 22a and a protruding section 22c formed on the supporting surface 22a. FIG. 5A is a cross-sectional view, and FIG. 5B is a perspective view of the sheet feeding unit 2. FIG. 5C conceptually illustrates how air is vented through the air venting path 22b. The protruding section 22c is formed on the supporting surface 22a of the rolled-sheet cover 22 along the longitudinal direction of the rolled-sheet cover 22. The protruding section 22c, which has a convex cross section, protrudes by a small distance from the supporting surface 22a. The protruding section 22c is formed on the supporting surface over a length that is equal to or larger than the maximum width (or a width slightly smaller than the maximum width) of the cut sheet C to be used in the printer body 1. The protruding section 22c includes a continuous protrusion or discrete protrusions. FIGS. 5A to 5C illustrate an example of the protruding section 22c that includes a continuous protrusion. In this example, the junction between the protruding section 22c and the supporting surface 22a is the air venting path 22b.

When the cut sheet C is placed on the supporting surface 22a, a part of the cut sheet C is supported by the protruding section 22c and uniformly rises above the supporting surface 22a in the width direction of the cut sheet C against the rigidity of the cut sheet C, while the remaining part of the cut sheet C follows the curve of the supporting surface 22a. At this time, gaps are generated between the supporting surface 22a and the back surface of the cut sheet C in a vicinity of the junction at which the protruding section 22c and the supporting surface 22a are joined to each other. The gaps serve as an air venting path, and the space A communicates with the outside through the lateral sides of the space A as illustrated in FIG. 5C. Whatever the size of the cut sheet C may be, the air in the space A between the cut sheet C and the supporting surface 22a is rapidly vented from the lateral sides of the air venting path 22b as indicated by an arrow S in FIG. 5C. As a result, the cut sheet C rapidly contacts the supporting surface 22a excluding a region on which the protruding section 22c is formed. Therefore, the cut sheet C is reliably supported by the supporting surface 22a.

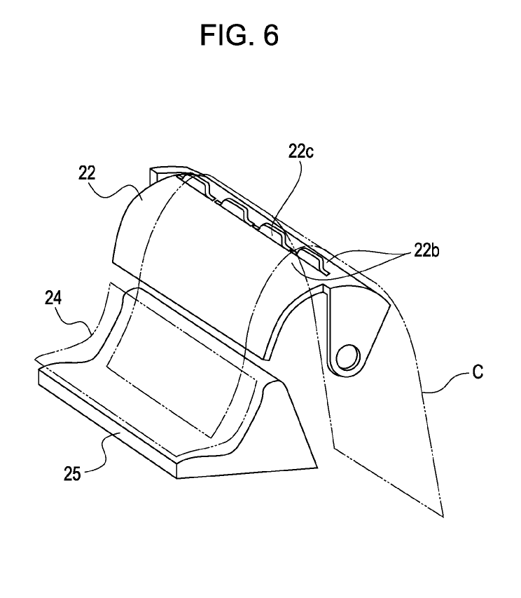

The protruding section of the air venting path 22b may not be a continuous protrusion extending in the longitudinal direction as illustrated in FIGS. 5A to 5C, and may include a plurality of discrete protrusions that are arranged in the width direction as illustrated in FIG. 6. In this case, the paths that connect junctions between the protrusions and the supporting surface 22a to each other correspond to the air venting path 22b. The intervals between the protrusions are set at a length (for example, smaller than 100 mm) at which the cut sheet C is prevented from being creased, curled, or bent when the cut sheet C is supported by the supporting surface 22a.

As described above, in the second example, the protruding section 22c is continuously or discreetly formed on the supporting surface 22a along the width direction of the sheet over a length that is equal to or larger than the maximum length of the sheet supporting surface, and the air venting path is a junction between the protruding section and the supporting surface. When the sheet is supported by the supporting surface 22a and the protruding section, a part of the sheet uniformly rises above the supporting surface in the width direction of the sheet at the air venting path against the rigidity of the sheet. This structure has the following benefits.

(1) The rolled-sheet cover 22 can be easily manufactured, and the component cost can be reduced.
(2) The air venting paths are disposed on both sides of the protruding section, so that air is vented more efficiently.
(3) When opening or closing the rolled-sheet cover 22, a user can hook his/her finger to the protruding section so as to have a handhold, whereby the protruding section improves the operability of opening and closing the rolled-sheet cover 22.
(4) A user can pick up a sheet that has been placed on the rolled-sheet cover 22 by inserting his/her finger from a region in which the sheet does not contact the rolled-sheet cover 22 so at to lift the sheet. Thus, operability for a user is high.

### Third Example of Air Venting Path

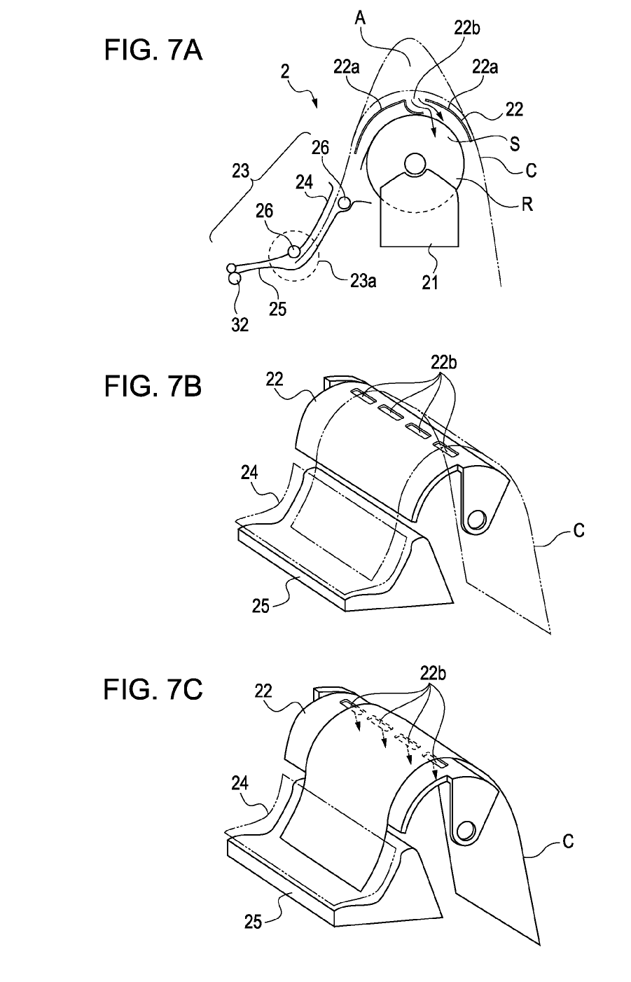

FIGS. 7A to 7C illustrate a third example of the air venting path 22b that includes through holes extending through the supporting surface. The air venting path illustrated in FIGS. 10A to 10F, with which movement of the sheet is described above, is of this type. FIG. 7A is a cross-sectional view, and FIG. 7B is a perspective view of the sheet feeding unit 2. FIG. 7C conceptually illustrates how air is vented through the air venting path 22b. The air venting path 22b includes through holes formed in the supporting surface 22a along the longitudinal direction of the rolled-sheet cover 22. Air communicates between the front surface side and the back surface side of the rolled-sheet cover 22 through the through holes. The air venting path 22b is continuously or discreetly formed over a length that is equal to or larger than the maximum width (or a width slightly smaller than the maximum width) of the cut sheet C to be used in the printer body 1. FIG. 7B illustrates an example in which a plurality of holes are discreetly formed. Whatever the size of the sheet may be, the air in the space A between the cut sheet C and the supporting surface 22a is rapidly vented from the back side of the rolled-sheet cover 22 as indicated by an arrow S in FIG. 7C. As a result, the cut sheet C rapidly contacts the supporting surface 22a and is reliably supported by the supporting surface 22a.

The air venting path 22b is to include a plurality of holes arranged in the width direction of the sheet as illustrated in FIG. 7B in consideration of the strength of the component. However, the air venting path 22b may be a continuous hole extending in the width direction of the sheet (longitudinal direction of the rolled-sheet cover 22) as illustrated in FIG. 7B. When the air venting path 22b includes a plurality of holes, the hole/land ratio and the intervals between the holes are determined so that air in the space A can be rapidly vented through the holes when the cut sheet C falls onto the rolled-sheet cover 22. To be specific, the hole/land ratio can be equal to or greater than 0.1, and the intervals between the holes can be equal to or smaller than 100 mm.

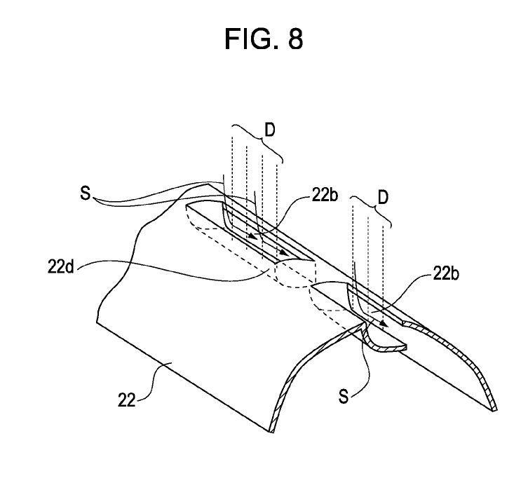

The rolled-sheet cover 22 has fundamental functions such as those of a dust cover and a protector for a rolled sheet. Therefore, as illustrated in FIGS. 7A and 8, the hole, which serves as the air venting path, may not be a simple through-hole and can have a so-called louvered structure having a cross section that is substantially L-shaped. That is, the rolled-sheet cover 22 is configured so that a rolled-sheet disposed under the rolled-sheet cover 22 cannot be seen or can only slightly be seen from the outside by being shielded by the louver. Therefore, in FIG. 8, dust D that falls into the hole from above the rolled-sheet cover 22 can be almost entirely received by a receiving surface 22d of the louvered structure, so that deposition of the dust D on the outer periphery of the rolled sheet R is suppressed. Moreover, even if a user inserts his/her finger or a foreign object through the hole, the receiving surface 22d blocks such an object, whereby the object is prevented from contacting the rolled sheet R. Air can flow through the hole in the direction indicated by an arrow S, so that the inside and the outside of the rolled-sheet cover 22 communicate with each other.

As described above, in the third example, the air venting path includes one or a plurality of holes that are disposed along the width direction of the sheet and extend through the rolled-sheet cover 22 from the supporting surface to the back side of the supporting surface. Moreover, the holes have the louvered structure. This structure has the following benefits.

(1) Provided that the louvers do not completely block user's view when the rolled-sheet cover is in the closed position, the user can visually check through the holes whether the rolled sheet is present, of what type the rolled sheet is, how much amount of the rolled-sheet remains, and the like.
(2) The rolled-sheet cover 22 can be easily manufactured, and the component cost can be reduced.
(3) Because the air venting path is formed as holes, the air venting path does not substantially affect the position and posture of the sheet (does not cause a part of the sheet to rise above the supporting surface). Therefore, it is less likely that the sheet is creased or bent while being conveyed. Even if the sheet is placed on the rolled-sheet cover 22 for a long time, the sheet is less likely to be creased, bent, or curled.
(4) Because the rolled-sheet cover 22 does not have a protruding portion, the footprint of the apparatus does not increase when the rolled-sheet cover 22 is in the open position.

The air venting path 22b may have a shape that is a combination of the groove in the first example, the protrusion in the second example, and the hole in the third example. By using a combination, the benefits described above are combined. In short, the rolled-sheet cover 22 is to have an air venting path through which air can be rapidly vented from an air space that is temporarily formed between the back surface of the cut sheet C and the supporting surface of the rolled-sheet cover 22 when a user places the cut sheet C on the rolled-sheet cover 22.

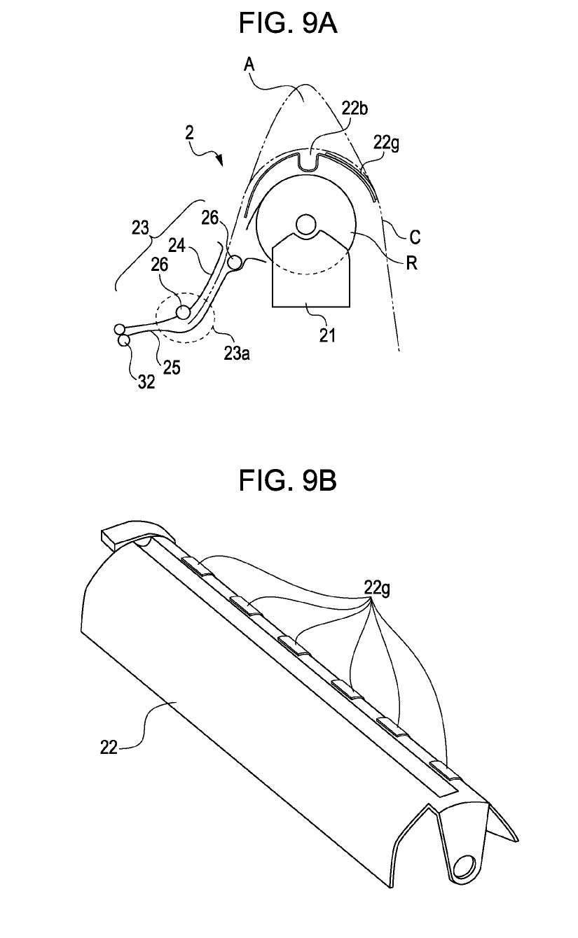

FIGS. 9A and 9B illustrate an example of a rolled-sheet cover that is further improved. FIG. 9A is a cross-sectional view, and FIG. 9B is a perspective view of the rolled-sheet cover. Friction members 22g are disposed at positions on the rolled-sheet cover 22 at which the rolled-sheet cover 22 contacts the cut sheet C (on an inclined surface on a side of the rolled-sheet cover 22 opposite the feeding path 23 side). The friction members 22g have a coefficient of friction greater than that of the supporting surface of the rolled-sheet cover 22. As illustrated in FIG. 9B, the friction members 22g may be arranged in the longitudinal direction of the rolled-sheet cover 22. Alternatively, the friction members 22g may be configured as a single continuous member. As the material of the friction member 22g, a material that has a high friction against the sheet is suitable. Examples of such a material include a rubber-based material (for example, EPDM rubber), a flocked material, a material having a cork-like surface, and a synthetic leather material. With this structure, when the cut sheet C is placed on the supporting surface, the friction members 22g contact the cut sheet C. Therefore, the speed at which the cut sheet C falls on the second end side as illustrated in FIGS. 10E to 10F is effectively reduced. The sheet is more reliably prevented from falling, because of the synergetic combination of the air venting path, which allows the sheet to rapidly contact the supporting path as described above, and the friction members, which serve to reduce the falling speed of the sheet. In FIGS. 9A and 9B, the air venting path 22b is a groove. However, a friction member may be disposed on the rolled-sheet cover in a similar manner when the air venting path 22b is a protruding section as in the second example or a hole as in the third example.

In the printer according to the present embodiment, the outer peripheral surface of the rolled-sheet cover, which protects the rolled-sheet from dust or contact with a foreign object, is used as a supporting surface for manual sheet feeding. Therefore, it is not necessary to dispose an independent member for manual sheet feeding, whereby an increase in cost and an increase in the size of the apparatus can be suppressed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-066508 filed Mar. 18, 2009, which is hereby incorporated by reference herein in its entirety.

What is claimed is:

1. An apparatus comprising:
a supporting surface including a curved surface that is convex in a direction opposite to gravity, the supporting surface supporting a sheet under a weight of the sheet, wherein an air venting path is disposed at the supporting surface, the air venting path allowing air to be vented from an air space between the supporting surface and the sheet placed on the supporting surface;
a holding section holding an end of the sheet, the sheet drooping toward both sides of the supporting surface; and
a feeding path through which the sheet is fed from the holding section side to a processing unit.

2. The apparatus according to claim 1,
wherein the air venting path is a groove formed in the supporting surface, the air venting path extending in a width direction of the sheet over a length that is larger than a maximum width of the sheet to be used.

3. The apparatus according to claim 1,
wherein a protruding section is formed on the supporting surface along a width direction of the sheet over a length equal to or larger than a maximum length of the sheet to be used, the protruding section including a continuous protrusion or discrete protrusions.

4. The apparatus according to claim 3,
wherein the air venting path is a junction between the protruding section and the supporting surface, and
wherein the sheet is supported by the protruding section in such a manner that a part of the sheet uniformly rises above the supporting surface at the junction along the width direction of the sheet.

5. The apparatus according to claim 1,
wherein the air venting path includes a hole that is disposed along a width direction of the sheet, the hole extending from the supporting surface to a back side of the supporting surface.

6. The apparatus according to claim 5,
wherein the hole has a louvered structure.

7. The apparatus according to claim 1,
wherein the air venting path is formed within a vertically projected area of the supporting surface.

8. The apparatus according to claim 1,
wherein the air venting path is formed in the supporting surface in such a manner that a center of the air venting path is disposed between regions that the sheet can contact, the sheet drooping toward both sides, when the sheet falls after the sheet is held above the supporting surface.

9. The apparatus according to claim 1,
wherein the air venting path is formed at a position of the supporting surface, the position including a vertex of the supporting surface.

10. The apparatus according to claim 1,
wherein a friction member that applies frictional resistance to a back surface of the sheet is disposed on an inclined surface of the supporting surface.

11. The apparatus according to claim 10, wherein the inclined surface being located opposite the feeding path side, the friction member having a coefficient of friction that is larger than a coefficient of friction of the supporting surface.

12. The apparatus according to claim 10,
wherein the friction member is made of a rubber-based material, a flocked material, a material having a cork-like surface, or a synthetic leather material.

13. A printer comprising:
a printing unit that performs printing on a sheet;
a supporting surface including a curved surface that is convex in a direction opposite to gravity, the supporting surface supporting the sheet under a weight of the sheet, wherein an air venting path is disposed at the supporting surface, the air venting path allowing air to be vented from an air space between the supporting surface and the sheet placed on the supporting surface;
a holding section holding an end of the sheet, the sheet drooping toward both sides of the supporting surface; and
a feeding path through which the sheet is fed from the holding section side to the printing unit.

14. The printer according to claim 13, further comprising:
a holder that holds a rolled sheet to be fed to the feeding path; and
a rolled-sheet cover that covers an upper portion of the rolled sheet along an outer periphery of the rolled sheet.

15. The printer according to claim 14,
wherein the supporting surface is an upper surface of the rolled-sheet cover, and
wherein the sheet and the rolled sheet are fed to the printing unit through the feeding path.

16. The printer according to claim 14,
wherein the rolled-sheet cover can be opened and closed so as to load the rolled sheet, and
wherein the upper surface of the rolled-sheet cover serves as the supporting surface when the rolled-sheet cover is closed.

17. The printer according to claim 15,
wherein a rotation axis of the rolled-sheet cover is coaxial with a rotation axis of the rolled sheet.

18. The printer according to claim 13,
wherein the holding section is a curved narrow path included in the feeding path.

19. The printer according to claim 17,
wherein a scooped-out shape is formed in the curved narrow path so as to guide a leading end of the sheet.

20. The printer according to claim 13,
wherein the holding section is rollers that nip and feed the sheet or a mechanism that nips and feeds the sheet, the holding section being disposed in the feeding path.
